(19) United States
(12) Patent Application Publication
(10) Pub. No.: US 2004/0194063 A1
(43) Pub. Date: Sep. 30, 2004

(54) System and method for automated testing of a software module

(76) Inventor: Joel Pereira, Kirkland, WA (US)

Correspondence Address: SHOOK, HARDY & BACON LLP, 2555 GRAND BLVD, KANSAS CITY,, MO, 64108, US

(21) Appl. No.: 10/402,459

(22) Filed: Mar. 28, 2003

(51) Int. Cl. G06F 9/44

(52) U.S. Cl. 717/124; 717/120

(57) ABSTRACT

Systems and methods for testing the fault tolerance of a computer application or other software module include persistent storage of inputs and failure groups for the software under test. A test module may systematically fail system calls made by the software module at runtime. The test module may then detect an operational failure in the software module, indicating that a bug exists in the error-handling code of the software module. The test module may restart the software module and continue testing until error conditions are met. In embodiments, a test module may store and look up information about the conditions of the software module at the time the system call was made. This may ensure that the same system call is not failed twice under the same conditions. In other implementations, this information may be organized into groups, such that only one group of conditions needs to be examined in conjunction with a particular operational failure.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to the field of computer software, and more particularly to techniques for automatically testing computer software at runtime.

### BACKGROUND OF THE INVENTION

During the execution of computer software, such as a program, application, or other software module, the software module may request various resources from the operating system. Such a request is known as a system call. Some of the resources requested by a system call may be local. For example, a software module may require access to a local file or may request local memory from the machine in which the software module is running. Other requested resources may be remote or network-based. For example, a software module may request to open a network connection or may request access to an external database. In some circumstances, the operating system cannot grant the request, and the system call may be failed by the operating system. This may occur, for example, if the computer is out of memory, if the network connection is down, or for other reasons. It is preferable for a software module to perform gracefully and continue to operate, even when a system call is failed.

When a system call made by computer a software module is failed, it is therefore desirable for the software module to continue running, and possibly to present the user with an error message. Situations in which the application crashes, hangs, aborts, or otherwise exhibits an operational failure should be avoided. For this reason, software modules may contain not only functional code, which accomplishes the function of the software module, but also error-handling code. Error-handling code may include code that checks to ensure that resources are available and are functioning properly. Error-handling code may also include code that steps through particular operations if a resource is not available, to try to ensure that the software module does not fail.

During the development of a software module, a software designer or tester may exercise the error-handling capability of the application as well as its functionality. While functional code may be accessible through the user interfaces, error-handling code may be less accessible to a user, designer, or tester, and therefore more difficult to rigorously test. Furthermore, in some cases, the person tasked with testing the software module may not have access to the source code, but only the binary, further exacerbating the difficulty of testing the error-handling part of the application or other module.

Error testing may be performed by forcing error conditions to occur and observing the resulting behavior of the software module. If error-handling code for a particular failed system call is present and functioning, the application or other software module may handle the failed system call gracefully. However, cases in which the error-handling code does not function as anticipated, or in which there is no error-handling code to handle a particular failed system call, may result in bugs in the application. In these cases, the application or other software module may respond to a failed system call with an operational failure, such as an abort or a hang, which may be examined by the designer or tester to try to develop a possible fix.

The process of deliberately introducing error conditions to observe the behavior of the application or other software module is known as fault injection. One method of performing fault injection, known as source-based fault injection, involves modifying or adding statements in the source code to generate specific errors. Another method of performing fault injection, known as runtime fault injection, involves introducing errors into the operating environment by creating or simulating error-causing circumstances.

Runtime fault injection may offer advantages over source-based fault injection. Runtime fault injection does not necessarily require access to source code, so a tester may be able to perform tests at runtime even if he or she only has the binary. Furthermore, the modification of the source code in source-based fault injection may introduce unwanted or unpredictable behavior into the software module. It may be more realistic to insert faults into the environment of the software module at runtime, rather than inserting faults into the software module itself.

One way to induce runtime fault injection is to deliberately create a degraded environment for the software module. For example, a tester could generate a full or overflowed storage medium by generating and maintaining large data files. As another example, a tester could create a busy or saturated network by generating large amounts of network traffic. Other methods of creating these and other error conditions are possible. Observing the behavior of a software module under these circumstances may demonstrate the fault tolerance of the other software module to various conditions.

Generating challenging conditions to exercise a software module may, however, be difficult and time-consuming for the tester. Furthermore, creating those conditions may not be an effective use of resources. Memory, network bandwidth, and other resources that could be otherwise used by others may be tied up in testing. Therefore, it may be advantageous at times for the tester to simulate degraded conditions rather than to actually create them.

Effects of a compromised environmental condition on a software module may again include failed system calls returned by the operating system. Simulating degraded conditions for a software module can therefore be achieved by failing requests for resources and other system calls made by the application, without artificially saturating an actual network connection or other resources. As these faults may only affect the particular application under test, this may allow the machine or network to be used for purposes other than testing at the same time.

Systems for simulating environmental conditions may employ various schemes for determining which system calls to fail, or when to fail them. In some cases, the particular system calls to be failed may be determined entirely by the tester on a manual basis. In other cases, the particular calls to be failed may be determined entirely by the system. In yet other cases, the particular system calls to be failed may be partially determined by the system but may depend on user input. For example, the tester may specify that 10% of system calls should be failed at random, and the system may determine which particular calls to fail to conform to the tester specifications.

Regardless of the scheme used to determine which calls to fail, a typical testing system may not keep a record of which error conditions have been tested. Even in systems in which a record is kept temporarily, this record may not persist beyond the testing session. This may result in the same error conditions being tested repeatedly, possibly unknowingly, which may not be an efficient use of resources. Furthermore, if no record of tested error conditions is kept, it may not be possible to determine when termination conditions have been met and testing should be ceased. Therefore, testing may be terminated prematurely, before all possible cases are tested. This may result in bugs that are undetected by the testing scheme. To find bugs in a software module while minimizing the time and resources used in testing, it is therefore desirable to implement a failure injection scheme that keeps a persistent record of the error cases that have been tested.

In addition, during testing, the software module may handle one or more failed system calls gracefully before encountering a failed system call that has a bug associated with it and will cause an operational failure. Furthermore, after encountering a failed system call with an associated bug, the software module may encounter several other failed system calls before the operational failure manifests itself as a bug or other irregularity. Therefore, the tester may be required to examine each system call or each failed system call separately to determine which particular system call caused the software module's operational failure. Examination of each system call in turn may be time-consuming for the tester. It is desirable to shorten the list of system calls that are potentially associated with a particular operational failure.

Furthermore, when a software module encounters a failed system call and exhibits an operational failure, the testing session may be summarily ended. In this case, the tester may therefore be required to restart the software module to find more bugs. Such a testing system may be time-consuming for the tester in that it may require the tester to reboot or otherwise interact with the system frequently.

There is therefore a need among other things for a failure injection system that that keeps a persistent record of the error cases that have been tested. Furthermore, it is desirable to implement a system that reduces the number of system calls that must be examined in connection with a particular bug. In addition, it is desirable to implement a system that may detect multiple bugs without the interaction of a tester. Other problems exist.

### SUMMARY OF THE INVENTION

The invention overcoming these and other problems in the art relates in one regard to a system and method for automated testing of a software module, in which the host system retains or persists information about the various calls that resulted in a particular operational failure. After an operational failure has been detected, the system may restart the software module to detect other failures, exceptions or bugs, and may continue testing until termination conditions are met. Furthermore, in embodiments stored call information may be grouped into failure groups such that each operational failure of the software module is associated with one failure group. This may reduce the number of calls that are examined to find which call caused a particular operational failure.

### BRIEF DESCRIPTION OF THE DRAWINGS

The invention will be described with reference to the accompanying drawings, in which like elements are referenced with like reference numerals, and in which:

FIG. 1 is a flow chart showing the interaction between a software module and an operating system in normal operation.

FIG. 2 is a block diagram of a testing system for failure injection in accordance with an embodiment of the invention.

FIG. 3 illustrates information contained in a storage medium in accordance with an embodiment of the invention.

FIG. 4 is a block diagram of a software module under test in accordance with an embodiment of the invention.

FIG. 5 is a flow chart depicting a method for failure injection in accordance with an embodiment of the invention.

FIG. 6 is a flow chart depicting a method of reproducing an operational failure in a software module.

### DETAILED DESCRIPTION OF EMBODIMENTS

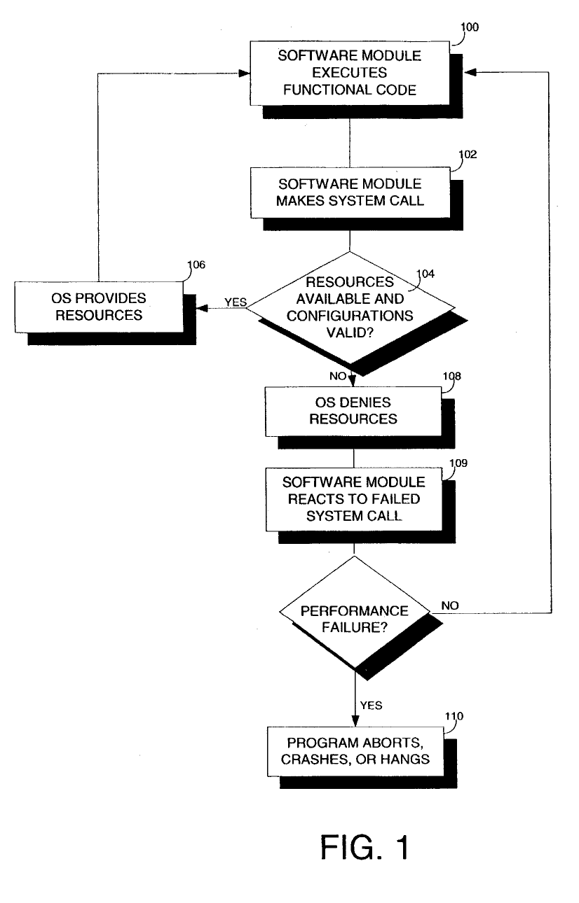

FIG. 1 is a flow chart showing interaction between a software module and an operating system in normal operation. While it is running, the software module may execute functional code in step 100. In step 102, the software module may make a system call to an operating system. The system call may be a process control call, such as a load call or a call to create a process, or may be a file manipulation call, such as a write call or a call to create a file. The system call may further be a device manipulation call, for example a call to request a device, an information maintenance call, for example a call to get time or date, or a communications call, such as a call to send or receive messages. Other system calls of these and other types are possible.

In step 104, the operating system may determine whether it is able to perform the system call, for example, by determining if sufficient resources are available or by determining if configurations are valid. For example, the operating system may determine whether sufficient memory exists to allocate new memory to the software module, or may determine whether a device is connected. If the operating system can fulfill the system call, it may do so in step 106 by providing the appropriate resources or by otherwise fulfilling the software module's request. The software module may then continue to execute functional code in step 100.

If the operating system is unable to fulfill the request in step 104, it may deny the request or other system call in step 108. This may include sending a message to the software module which alerts the software module to the fact that the operating system was unable to fulfill the system call. This may be accomplished, for example, by setting a return code to a particular value indicating that the system call was failed, or by some other means.

In step 109, the software module may react to the failed system call. In some implementations, the software module may change its internal state to reflect the fact that the system call failed. This may be done, for example, by generating an exception flag or other indicator. The software module may then continue executing the code. In executing the code, the software module may encounter code designed to take or change control of the software module's execution if a failed system call is detected. This may be, for example, code that traps an exception. The software module may then execute code to handle the failed system call, for example, by displaying an error message to a user or taking other action. The code that takes or changes control of execution in the case of a failure, and the code that handles the failure, may be referred to singly or collectively as error-handling code. If the error-handling code is present and fully functional in responding to the failed system call, there is no bug, and the software module may not exhibit operational failure. The software module may then continue executing functional code in step 100.

If the error-handling code is not present or is not fully functional, the software module may exhibit operational failure in step 110. Examples of operational failure include, but are not limited to, the software module aborting or hanging.

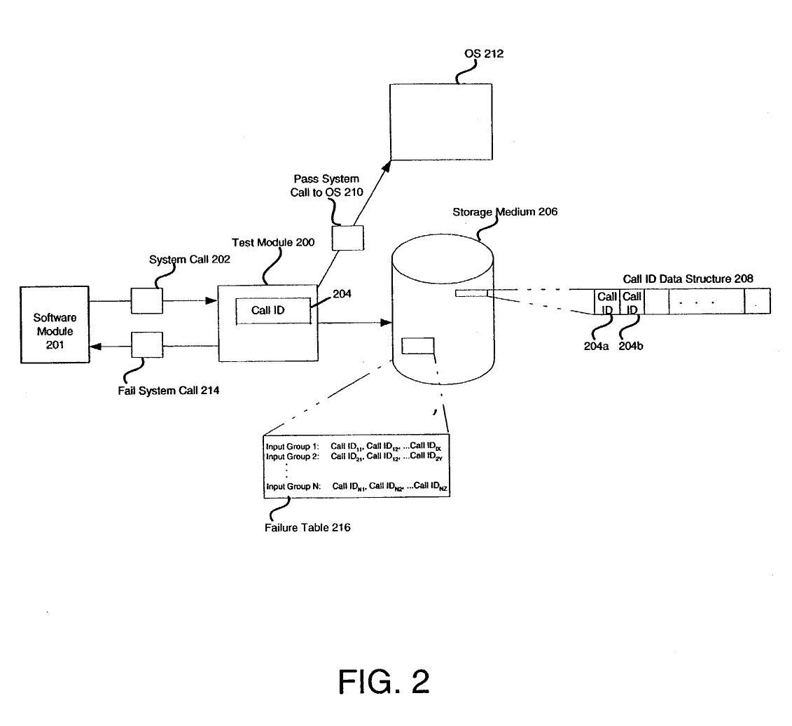

FIG. 2 is a block diagram of a testing system for failure injection in accordance with an embodiment of the invention. The testing system may include a test module 200. The test module 200 may be a computer program, application, or other software used to test the robustness of a software module 201.

In normal operation as generally illustrated in FIG. 1, a software module may pass system calls to an operating system. However, during testing, in the embodiment illustrated in FIG. 2 the software module 201 may pass system calls not to an operating system, but directly to the test module 200. This re-routing of the system calls may be accomplished, for example, through source-based interception, in which the binary may be edited to replace instances of the destination Application Programming Interface (API). Alternatively, re-routing of the system calls may be accomplished through in-route interception, in which a destination address is modified in a function dispatch table, or by some other method.

During testing, the software module 201 may pass a system call 202 to the test module 200. The test module 200 may further obtain a call identifier 204 from the software module 201. The call identifier 204 may correspond to a particular call condition in the software module 201. The call condition may be the system call 202, or may be any information that describes one or more conditions in the software module 201 that resulted in the system call 202. The call condition may be or include the instruction or subroutine that initiated the system call 202, or may be or include the call stack of the software module 201 at the time the system call 202 was made. The call identifier 204 corresponding to the call condition may be any datum that includes information about, or can be used to identify, the particular call condition. If the call condition includes the state of the call stack at the time of the system call 202, the call identifier 204 may include information about the call stack of the software module 201. For example, it may be a duplicate of the call stack, or may be a number or code that uniquely identifies the call stack. One such call identifier may be a cyclic redundancy check (CRC), a number, polynomial, or string of bits that is generated based on a source, such as a call stack, and that may uniquely identify the source. Alternatively or in addition, the call condition may be or include the subroutine or instruction that made the system call 202. In this case, the call identifier 204 may contain information about the subroutine or instruction. For example, the call identifier 204 may be an a copy of the name of a subroutine, an address of a subroutine, a copy of an instruction, or an address of an instruction. Alternatively, or in addition, the call condition may be or include the system call 202. In this case, the call identifier 204 may be the same as the system call 202. Other call conditions and call identifiers of other types may be used.

The call identifier 204 may correspond to a particular call condition in the software module 201. The call condition may be or include any information that describes one or more conditions in the software module 201 that resulted in the system call 202. The call identifier 204 may therefore be referred to as associated with the system call 202.

When the test module 200 has received the system call 202 and the call identifier 204, it may determine whether the system call 202 has previously been failed. This may be accomplished by searching a storage medium 206 for another call identifier 204a corresponding to same call condition identified by the call identifier 204. If the call identifier 204a corresponds to a call condition that led to the system call 202, the call identifier 204a may be referred to as associated with the system call 202. The call identifier 204a and other call identifiers contained in the storage medium 206 may be stored in a data structure 208, which may be a hash table to facilitate quick look-up, or may be another structure. The storage medium 206 may be a database, a text file, or any other storage medium. The storage medium 206 may be configured such that the information contained therein persists past the testing session.

Computers typically include a variety of storage media. The storage medium 206 includes any medium that can be accessed by a computer and includes both volatile and nonvolatile media, removable and non-removable media. By way of example, and not limitation, the storage medium 206 may comprise computer storage media and communications media. Computer storage media may include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD), holographic or other optical storage, magnetic cassettes, magnetic tape, magnetic disk storage or other magnetic storage devices, or any other medium which can be used to store the desired information and which can be accessed by a computer.

If, in searching the storage medium 206, the test module 200 finds a second call identifier 204a corresponding to the same call condition identified by the call identifier 204, the test module 200 may determine that the system call 202 has been failed before. In this case, the test module 200 may elect not to fail the system call 202 again, but rather to pass a system call 210 to an operating system 212. The system call 210 may be the same as or may be a duplicate of the system call 202. The operating system 212 may then execute the system call 210 if it is able to do so, or may fail the system call 210 if it is not able to fulfill it.

If the test module 200 is unable to find a second call identifier 204a corresponding to the same call condition as the call identifier 204, it may determine that the system call 202 has not yet been failed. In this case, it may fail the system call 202, for example, by sending the software module 201 a message 214 with a particular return code, and by neglecting to pass the system call 202 on to the operating system 212. The test module 200 may then store a call identifier 204b into the storage medium 206. The call identifier 204b may correspond to a call condition that led to the system call 202, and may therefore be associated with they system call 202. The call identifier 204b may correspond to the same call condition as the call identifier 204. The call identifier 204b may allow the test module 200 to recognize and fail the system call 202 if it is encountered again.

In addition to or instead of storing the call identifier 204b in a data structure 208, the test module 200 may store the call identifier 204b in a failure table 216. The failure table 216 may be located in the storage medium 206 or may be located elsewhere. Such a failure table may group the call identifier 204b and other call identifiers into failure groups, each failure group corresponding to one set of inputs to the software module 201, or corresponding to one operational failure of the software module 201.

If the call identifier 204 corresponds to the call stack of the software module 201, for example, if the call identifier 204 is a copy or CRC of the call stack, the effect of the lookup in the storage medium 206 may be to determine whether the system call 202 has yet been failed with the call stack in its present state. In this case, the same system call 202, called by the same instruction or subroutine, may be failed repeatedly with the call stack in different states. This may be a more exhaustive method of testing, as the system call 202 may pass different parameters when it is called from different call stacks. Furthermore, this method of testing may be more exhaustive because the same failed system call 202 may be handled by error-handling code in one sub-routine when the call stack is in a first state, and may be handled by different error-handling code in a different sub-routine, or may not be handled at all, when the call stack is in a second state.

In contrast, if the call identifier 204 corresponds to only the sub-routine or instruction that made the system call 202, the effect of the lookup in the storage medium 206 may be to determine whether the system call 202 has been failed when called by the same sub-routine or instruction. This may not be an exhaustive method of testing because some bugs may escape detection. For example, in the software module 201, a system call 202 may be called by a sub-routine A, but a failure of the system cal 202 may not be detected or handled by that sub-routine A. However, another sub-routine B further down in the call stack may detect the failed system call 202 and handle it gracefully. In this case, no bug may exist because the software module 201 does not exhibit operational failure. Later on in the execution of the software module 201, sub-routine A may again make the same system call 202, but sub-routine B may be absent from the call stack. In this case, a failure of the system call 202 may not be handled by any sub-routine in the call stack, and a bug may exist. However, because the test module 200 recognizes the sub-routine or instruction that initiated the system call 202, the system call 202 may not be failed again, the behavior of the software module 201 when the system call 202 is failed may not be observed, and the bug may go undetected. For these reasons it may be more exhaustive for the call identifier 204 to reference the call stack of the software module 201, and not only the sub-routine or instruction.

Furthermore, if call identifier 204 references only the system call 202, the effect of the lookup in the storage medium 206 may be to determine whether the same system call has been failed under any conditions. This may not be an exhaustive method of testing because some bugs may escape detection. The same system call may be made under many different conditions, and error-handling code may be present and functional under some conditions and lacking or not fully functional in others. It may therefore be more exhaustive for the call identifier 204 to reference the call stack of the software module 201, and not only the system call.

When the test module 200 detects an operational failure of the software module 201, it may restart the software module 201. In performing this restart, the test module 200 may provide the software module 201 with a new set of inputs or otherwise restart it under different conditions. The new set of inputs or initial conditions may be distinct from the sets of inputs or initial conditions that the software module 201 has thus far received. This may enable testing of different conditions from those that have been observed before. Upon restart, the test module 200 may further initiate a new failure group in the failure tables 216 and 218. These failure groups may be associated with the new set of inputs or initial conditions.

The test module 200 may be described in the general context of computer-executable instructions, such as program modules. Generally, program modules include routines, programs, objects, components, segments, schemas, data structures, etc. that perform particular tasks or implement particular abstract data types. The test module 200 may also be practiced in distributed computing environments where tasks are performed by remote processing devices that are linked through a communications network. In a distributed computing environment, program modules may be located in both local and remote computer storage media including memory storage devices. may be described in the general context of computer-executable instructions, such as program modules. Generally, program modules include routines, programs, objects, components, segments, schemas, data structures, etc. that perform particular tasks or implement particular abstract data types. The test module 200 may also be practiced in distributed computing environments where tasks are performed by remote processing devices that are linked through a communications network. In a distributed computing environment, program modules may be located in both local and remote computer storage media including memory storage devices.

The test module 200 may be implemented in a variety of computing system environments. For example, each of the components and subcomponents of the test module 200 may be embodied in an application program running on one or more personal computers (PCs). This computing system environment is only one example of a suitable computing environment and is not intended to suggest any limitation as to the scope of use or functionality of the invention. The test module 200 may also be implemented with numerous other general purpose or special purpose computing system environments or configurations. Examples of other well-known computing systems, environments, and/or configurations that may be suitable for use with the invention include, but are not limited to, server computers, hand-held or laptop devices, multiprocessor systems, microprocessor-based systems, programmable consumer electronics, network PCs, minicomputers, mainframe computers, distributed computing environments that include any of the above systems or devices, and the like.

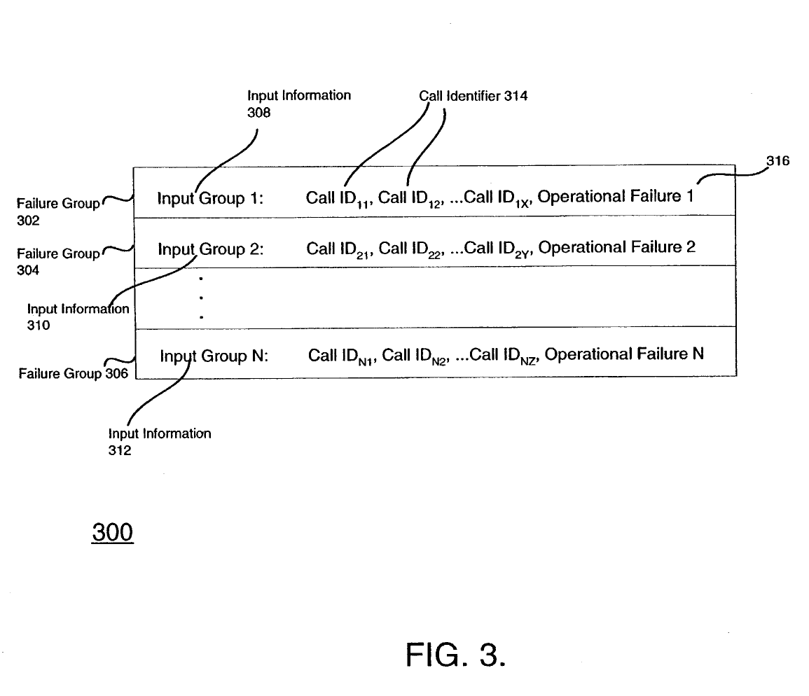

FIG. 3 illustrates information contained in a storage medium in accordance with an embodiment of the invention. The information may be organized to form a failure table 300. The information may be organized into one or more failure groups 302, 304, 306. Each failure group 302, 304, 306 may be associated with input information 308, 310, 312. This input information 308, 310, 312 may reflect the set of inputs or initial conditions of a software module upon beginning execution or upon restart. The input information 308, 310, 312 may be stored inside the failure group 302, 304, or 306 or may be stored elsewhere.

Each failure group 302, 304, 306 may contain a group or list of call identifiers 314. The failure table 300 may contain various types of call identifiers referencing various types of call conditions, or may contain only one type of call identifier referencing one type of call conditions.

When a software module is started or restarted, input information 308 identifying the set of inputs or initial conditions may be stored. In addition, a failure group 302, which may be associated with the input information 308, may be opened. Once the failure group 302 is opened, one or more call identifiers 314 may be stored in the failure group 302. As a software module executes and a test module fails system calls, one or more call identifiers 314 associated with failed system calls may be stored in failure group 302. These may include call identifiers 314 corresponding to the call stack, sub-routine, or instruction that made the failed system call, or may include call identifiers 314 associated with the failed system call.

When the software module exhibits an operational failure, operational failure information 316 may be stored, either in the failure table 300 or elsewhere. In addition, a failure group 302 may be closed. The software module may be restarted, and input information 310 may be stored. A new failure group 304 may then be opened. The process of restarting the software module and opening a new failure group 304 may continue until termination conditions are met.

The process of opening a failure group 302, optionally storing input information 308, storing one or more call identifiers 314, optionally storing operational failure information 316, and optionally closing the failure group 312 may be referred to as generating the failure group 302. Input information 308, call identifiers 314, and operational failure information 316 may be referred to as contained in or associated with the failure group 302.

To find a call that resulted in a particular operational failure identified by operational failure information 316, a may determine what failure group 302 is associated with operational failure information 316. The tester may need only to examine the system calls calls associated with the call identifiers 314 in the particular failure group 302. Furthermore, the operational failure may be duplicated by restarting the software module with the set of inputs or initial conditions corresponding to the input information 308 associated with the failure group 302.

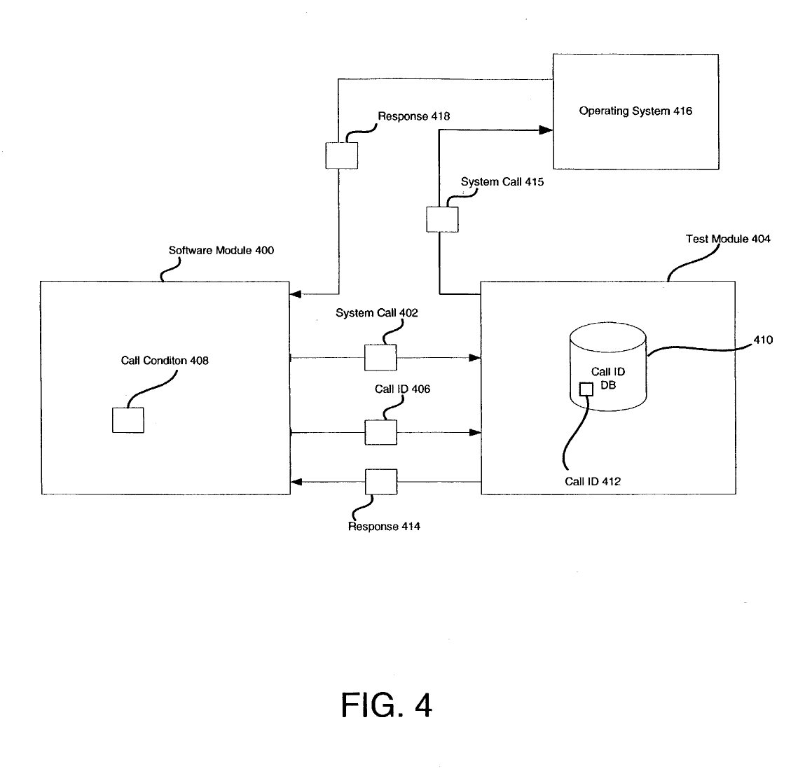

FIG. 4 is a block diagram of a software module 400 according to an aspect of the invention. The software module 400 may be a computer program, application, or other software to be tested. While the software module 400 executes, it may make one or more system calls 402. These system calls 402 may be routed to a test module 404. The software module 400 may further send to the test module 404 one or more call identifiers 406. The call identifier 406 may identify a call condition 408 in the software module 400. The call condition 408 may be any information that describes a condition in the software module 400 that resulted in the system call 402, or may be system call 402. The call condition 408 may be, for example, the state of the call stack when the system call 402 was made, may be a sub-routine or instruction that made the system call 402, or may be system call 402.

The call identifier 406 may correspond to a call condition 408 in the software module 400. The call condition 408 may be or include any information that describes one or more conditions in the software module 400 that resulted in the system call 402. The call identifier 406 may therefore be referred to as associated with the system call 402.

In response to the system call 402 and the call identifier 406, the test module 404 may examine a storage medium 410 to determine whether another call identifier 412 corresponding to the call condition 408 is present. If such a call identifier 412 is present, the test module 404 may fail the system call 402, and may send a response 414 to the software module 400, the response 414 indicating that the system call 402 has been failed. If such a call identifier 412 is not present in the storage medium 410, the test module 404 may pass a system call 415 on to an operating system 416. The system call 415 may be the same as or may be a duplicate of the system call 402. The operating system 416 may fail or execute the system call 415, and may send a response 418 to the software module 400. The response 418 may indicate whether the system call 415 has been fulfilled.

The call identifier 412 may correspond to a call condition 408 in the software module 400. The call condition 408 may be or include any information that describes one or more conditions in the software module 400 that resulted in the system call 402. The call identifier 408 may therefore be referred to as associated with the system call 402.

The software module 400 may be described in the general context of computer-executable instructions, such as program modules. Generally, program modules include routines, programs, objects, components, segments, schemas, data structures, etc. that perform particular tasks or implement particular abstract data types. The software module 400 may also be practiced in distributed computing environments where tasks are performed by remote processing devices that are linked through a communications network. In a distributed computing environment, program modules may be located in both local and remote computer storage media including memory storage devices. may be described in the general context of computer-executable instructions, such as program modules. Generally, program modules include routines, programs, objects, components, segments, schemas, data structures, etc. that perform particular tasks or implement particular abstract data types. The software module 400 may also be practiced in distributed computing environments where tasks are performed by remote processing devices that are linked through a communications network. In a distributed computing environment, program modules may be located in both local and remote computer storage media including memory storage devices.

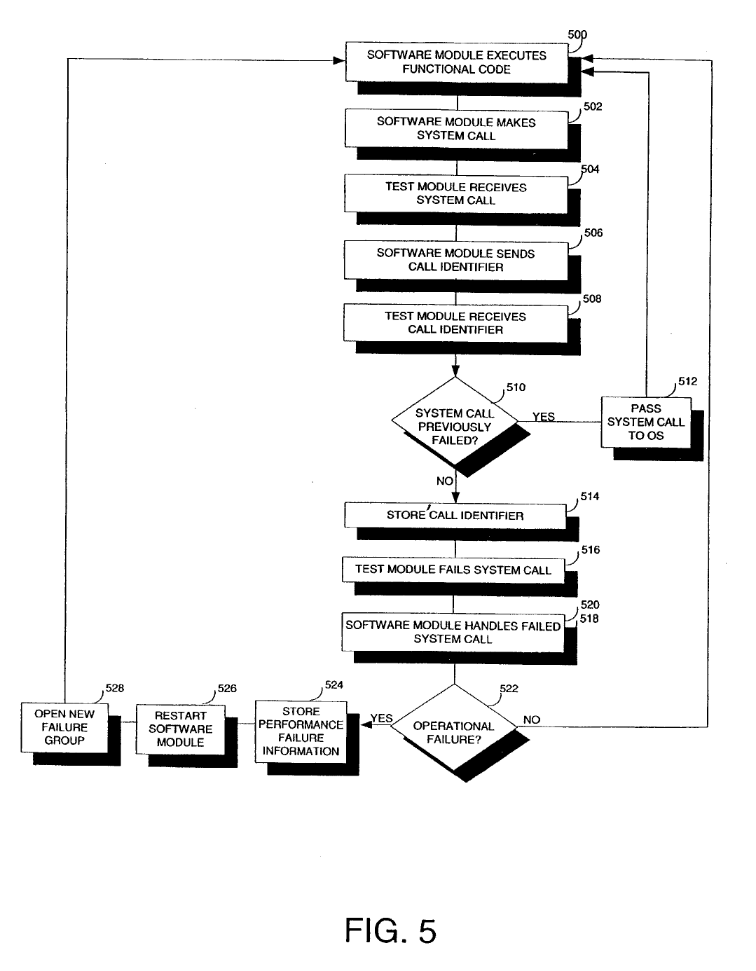

FIG. 5 is a flow chart depicting a method for failure injection in accordance with an embodiment of the invention. The method may begin in step 500, wherein a software module may execute functional code. The method may continue in step 502, wherein the software module may make a system call. The system call may be routed to a test module, and in step 504, the test module may receive the system call. In step 506, the software module may send a call identifier. This call identifier may correspond to a call condition, which may be any information concerning the conditions in the software module that led to the system call, or may be the system call itself. The call identifier may be associated with the system call. In step 508, the test module may receive the call identifier.

The process may continue in step 510, wherein the test module may determine whether the system call has previously been failed. The test module may determine this, for example, by searching a storage medium for a second call identifier corresponding to the call condition, by searching a storage medium for a second call identifier associated with the system call, or by some other means. In some implementations, the step of determining whether the system call has previously been failed 510 may be equivalent to determining whether a system call has previously been received when the call stack of the software module was in the same state. In other implementations, the step of determining whether the system call has previously been failed 510 may be equivalent to determining whether a system call has previously been received and has been initiated by the same subroutine or instruction. In yet other implementations, the step of determining whether the system call has previously been failed may be equivalent to determining whether the system call has previously been received under any conditions.

If the test module determines that the system call has previously been failed, it may pass the system call to an operating system in step 512. The operating system may execute the system call (not shown), and the process may return to step 500, in which the software module may execute functional code. If the test module determines that the system call has not previously been failed, it may, in step 514, store a call identifier corresponding to the call condition. The call identifier may be stored, for example, in one or more data structures such as hash tables, failure tables, or others, in any storage medium. The test module may then, in step 518, fail the system call, for example, by failing to pass the system call to the operating system and by sending a message to the software module.

The software module may exhibit operational failure in step 522 due to the failed system call. If the software module does not exhibit operational failure in step 522, the software module may continue to execute functional code in step 500. If the software module does exhibit operational failure in step 522, for example, by crashing, aborting or hanging, the test module may store information about the operational failure in step 524. The software module may be restarted in step 526. The software module may be restarted, for example, by the test module, and may be restarted with inputs or initial conditions that are distinct from those that were present in previous starts. The test module may open a new failure group in step 528. In some implementations, this may include a step of storing information about the set of inputs or initial conditions. The software module may then execute functional code in step 500.

The process of optionally opening a failure group in step 528, optionally storing input information, storing one or more call identifiers in step 514, optionally storing performance failure information in step 524, and optionally closing the failure group may be referred to as generating a failure group. The input information, the one or more call identifiers, and the performance failure information stored while generating a failure group may be described as being contained in or being associated with the failure group.

If the software module finishes execution without exhibiting an operational failure, the test module may restart the software module (not shown) with a set of inputs and initial conditions that is distinct from any that have been used previously, to continue testing the system.

The test module may continue to test the software module until termination conditions are met. If the test module has restarted the software module multiple times and all system calls in recent input groups have been passed to the operating system, a tester may conclude with some degree of certainty that all system calls have previously been failed, and all bugs have therefore been detected. The greater the number of times the software module has been restarted since the last failed system call, the greater the certainty may be that all bugs have been detected. Various implementations may therefore have various termination conditions, depending on the degree of certainty specified. Alternatively, in embodiments the test module may search the storage medium to determine whether all possible system calls have been failed.

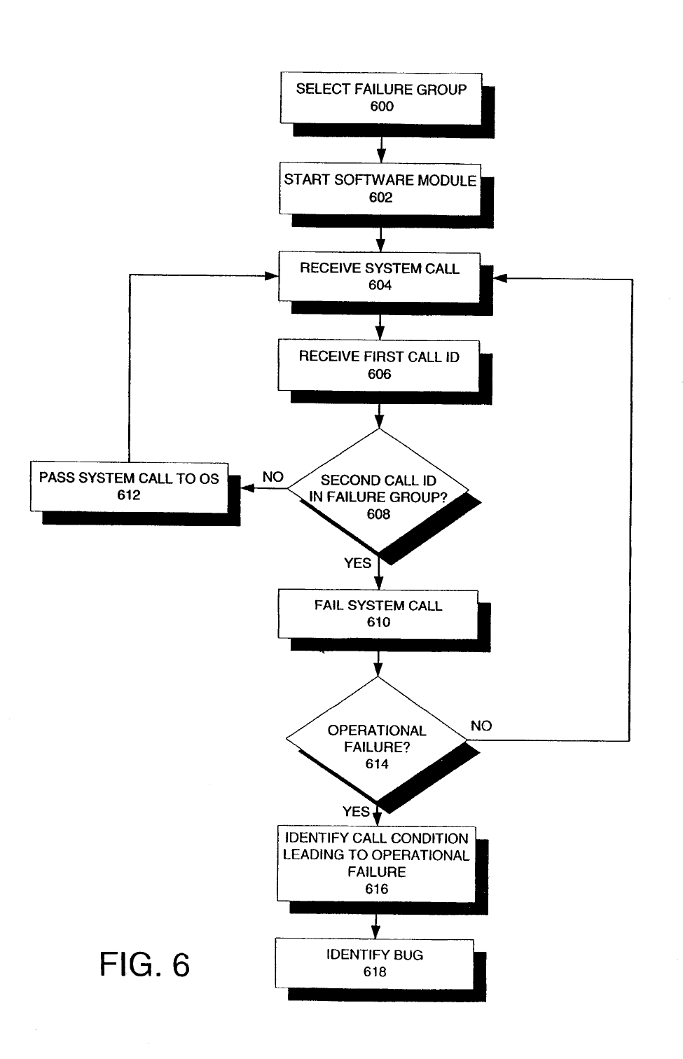

FIG. 6 is a flow chart depicting a method of reproducing an operational failure in a software module. The method may begin in step 600, wherein a failure group may be selected. The failure group may be selected, for example, from a failure table that includes one or more failure groups. The failure group may be selected by a tester. In embodiments, the tester may select a failure group that is associated with a particular operational failure. Selecting a failure group that is associated with a particular operational failure may allow the tester to reproduce the operational failure, or to examine the conditions that led to the operational failure.

The method may continue in step 602, wherein a software module may be started. The software module may be the same software module that was tested by a testing system to generate the failure group. The software module may be started under a set of inputs or initial conditions that are associated with the failure group. This may be the same set of inputs or initial conditions under which the software module was started to generate the failure group.

The method may continue in step 604, wherein a system call may be received. The system call may be received from the software module. In step 606, a call identifier corresponding to a call condition may be received. The call identifier may be received from the software module, and may correspond to a call condition in the software module. For example, the call condition may be the stack of the software module at the time the system call was made or an instruction or subroutine in the software module that initiated the system call. Alternatively, the call condition may be the system call itself. In this case, steps 604 and 606 may be combined.

In step 608, the failure group may be examined for the presence of a second call identifier corresponding to the call condition. The presence of such a second call identifier may indicate that the system call was failed at the time the failure group was being generated. In order to reproduce the behavior of the software module, the system call may therefore be failed in step 610. The absence of such a second call identifier may indicate that the system call was passed on to an operating system at the time the failure group was being generated. In order to reproduce the behavior of the software module, the system call may therefore be passed on to an operating system in step 612.

In step 614, operational failure of the software module may be observed. The operational failure that is observed may be the same as the operational failure associated with the failure group. If operational failure is not observed, the method may return to step 604, wherein a system call may be received. If an operational failure is observed, the call condition that led to the operational failure may be identified. This may be include determining whether the most recent call condition led to the operational failure. Alternatively, it may include identifying which call condition in the failure group or which failed system call led to the operational failure. If the call condition is a system call, determining whether the call condition led to the operational failure may be equivalent to determining whether the failure of the system call caused the operational failure. If the call condition is a stack, an instruction, or a subroutine, determining whether the call condition led to the operational failure may be equivalent to determining whether the call condition is associated with or includes a system call that was failed and caused an operational failure. Conventional testing techniques such as stepping through code or examining internal states and variables of the software module may be used in identifying the call condition or failed system call that led to the operational failure.

The method may continue in step 618, wherein a bug may be identified. The bug that is identified may be a bug that is associated with the operational failure. Identifying a bug may include, for example, identifying an instance in which error-handling code is non-functional or non-existent. The bug may be identified using conventional methods, techniques, and tools. If a call condition that led to the operational failure has been identified in step 616, identifying the bug may be expedited.

The method of reproducing an operational failure may simplify or expedite the testing process. Conventional testing may require examining many call conditions to determine which call condition led to a particular operational failure. In the method described above, it may be necessary only to examine the call conditions included in a particular failure group. Since the number of call conditions that is examined may be reduced, the testing process may therefore be expedited.

The foregoing description of the invention is illustrative, and modifications in configuration and implementation will occur to persons skilled in the art. For instance, while the invention has generally been described in terms of containing one failure table, in embodiments it may employ multiple failure tables. Furthermore, each failure table may contain one type of call identifier, or multiple types of call identifiers. In addition, a user interface designed to facilitate user interaction with the test module may be provided. Hardware, software or other resources described as singular may in embodiments be distributed, and similarly in embodiments resources described as distributed may be combined. The scope of the invention is accordingly intended to be limited only by the following claims.

I claim:

1. A method for testing software, the method comprising the steps of:
receiving a system call from a software module;
determining whether a first call identifier associated with the system call is contained in a storage medium;
failing the system call if the first call identifier is not contained in the storage medium; and
passing the system call to an operating system if the first call identifier is contained in the storage medium.

2. A method according to claim 1, wherein the steps are repeated in response to subsequent system calls.

3. A method according to claim 1, further comprising the step of determining whether an operational failure of the software module occurred.

4. A method according to claim 1, wherein a bug is identified if an operational failure of the software module occurred.

5. A method according to claim 1, further comprising the step of restarting the software module if an operational failure of the software module occurred.

6. A method according to claim 5, wherein inputs to the software module upon restart are distinct from previous inputs to the software module.

7. A method according to claim 1, wherein the first call identifier corresponds to a call stack of the software module.

8. A method according to claim 1, wherein the first call identifier comprises a CRC of a call condition.

9. A method according to claim 1, wherein information in the storage medium is persistent.

10. A method according to claim 1, further comprising the step of storing in the storage medium a second call identifier associated with the system call if the first call identifier is not contained in the storage medium

11. A method according to claim 10, wherein the second call identifier corresponds to a call stack of the software module.

12. A method according to claim 10, wherein the second call identifier is stored in a hash table.

13. A method according to claim 10, wherein the second call identifier is associated with a failure group.

14. A method according to claim 13, wherein input information is associated with the failure group.

15. A method according to claim 13, wherein operational failure information is associated with the failure group.

16. A testing system for handling system calls, comprising:
a storage medium; and
a test module configured to fail a system call if a first call identifier associated with the system call is contained in the storage medium, and to pass the system call to an operating system otherwise.

17. A system according to claim 16, wherein the test module is further configured to determine whether an operational failure of a software module occurs.

18. A system according to claim 16, wherein a bug is identified if an operational failure of a software module occurs.

19. A system according to claim 16, wherein the test module is further configured to restart a software module if an operational failure of the software module occurs.

20. A system according to claim 19, wherein inputs to the software module upon restart are distinct from previous inputs to the software module.

21. A system according to claim 16, wherein the first call identifier corresponds to a call stack.

22. A system according to claim 16, wherein information in the storage medium is persistent.

23. A system according to claim 16, wherein the testing system is configured to store a second call identifier associated with the system call in the storage medium if the first call identifier associated with the system call is not contained in the storage medium.

24. A system according to claim 23, wherein the second call identifier is stored in a hash table.

25. A system according to claim 23, wherein the second call identifier is associated with a failure group.

26. A system according to claim 25, wherein input information is associated with the failure group.

27. A system according to claim 25, wherein operational failure information is associated with the failure group.

28. A system for making system calls, comprising:
a software module configured to make a system call to a test module, and to receive a response to the system call, the response being a failure of the system call if a storage medium contains a call identifier associated with the system call.

29. A system according to claim 28, wherein a bug is identified if an operational failure of the software module occurs.

30. A system according to claim 28, wherein the call identifier corresponds to a call stack of the system.

31. A system according to claim 28, wherein the call identifier comprises a CRC of a call condition.

32. A computer-readable medium, the computer-readable medium being readable to execute a method of:
receiving a system call;
determining whether a first call identifier associated with the system call is contained in a storage medium;
failing the system call if the first call identifier is not contained in the storage medium; and
passing the system call on to an operating system if the first call identifier is contained in the storage medium.

33. A computer-readable medium according to claim 32, wherein the method further comprises a step of determining whether an operational failure of a software module occurred.

34. A computer-readable medium according to claim 32, wherein a bug is identified if an operational failure of a software module occurred.

35. A computer-readable medium according to claim 32, wherein the method further comprises a step of restarting a software module if an operational failure of the software module occurred.

36. A computer-readable medium according to claim 35, wherein inputs to the software module upon restart are distinct from previous inputs to the software module.

37. A computer-readable medium according to claim 32, wherein the method is repeated until termination conditions are met.

38. A computer-readable medium according to claim 32, wherein the call identifier corresponds to a call stack.

39. A computer-readable medium according to claim 32, wherein the call identifier comprises a CRC of a call condition.

40. A computer-readable medium according to claim 32, wherein information contained in the storage medium is persistent.

41. A computer-readable medium according to claim 32, wherein the method further comprises a step of storing in a storage medium a second call identifier associated with the system call if the first call identifier associated with the system call is not contained in the storage medium.

42. A computer-readable medium according to claim 41, wherein the second call identifier is associated with a failure group.

43. A system for testing software comprising:
means for receiving a system call;
means for determining whether a first call identifier associated with the system call is contained in a storage medium;
means for failing the system call if the first call identifier is not contained in the storage medium; and
means for passing the system call on to an operating system if the first call identifier is contained in the storage medium.

44. A system according to claim 43, further comprising means for storing in the storage medium a second call identifier associated with the system call if the first call identifier is not contained in the storage medium.

45. Executable program code, the executable program code having been tested by a process comprising:
receiving a system call;
determining whether a first call identifier associated with the system call is contained in a storage medium;
failing the system call if the first call identifier is not contained in the storage medium; and
passing the system call on to an operating system if the first call identifier is contained in the storage medium.

46. Executable program code according to claim 45, wherein execution of the process identifies one or more bugs in the executable program code.

47. Executable program code according to claim 45, wherein one or more bugs identified by the process are eliminated from the executable program code.

48. Executable program code according to claim 45, further comprising the step of storing in the storage medium a second call identifier associated with the system call if the first call identifier is not contained in the storage medium.

49. A method of reproducing an operational failure in software, comprising:
selecting a failure group;
receiving a system call from a software module;
failing the system call if a call identifier corresponding to the system call is contained in the failure group; and
passing the system call on to an operating system if a call identifier corresponding to the system call is not contained in the failure group.

50. A method according to claim 49, further comprising starting the software module under a set of inputs or initial conditions corresponding to the failure group.

51. A method according to claim 49, further comprising observing an operational failure.

52. A method according to claim 51, further comprising determining whether the system call led to the operational failure.

53. A method according to claim 49, further comprising identifying a bug.

54. A method for testing software, comprising the steps of:
receiving a system call from a software module;
determining whether the system call has previously been failed;
failing the system call if the system call has not previously been failed; and
passing the system call on to an operating system if the system call has previously been failed.
